(19) United States
(12) Patent Application Publication
(10) Pub. No.: US 2008/0048966 A1
(43) Pub. Date: Feb. 28, 2008

(54) DISPLAYING METHOD FOR LIQUID CRYSTAL DISPLAY

(75) Inventors: Bing Jei LIAO, Tainan County (TW); Chung Yuan Liu, Tainan County (TW); Yen Chen Chen, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX, Tainan County (TW)

(21) Appl. No.: 11/833,691

(22) Filed: Aug. 3, 2007

(30) Foreign Application Priority Data
Aug. 4, 2006 (TW) 095128592

(51) Int. Cl. G09G 3/18

(52) U.S. Cl. 345/102

(57) ABSTRACT

A displaying method for liquid crystal display, which has a light source integrated therein, includes the following steps: inputting a first video signal to the liquid crystal display during a first period of time and controlling the light source by means of modulating a light control signal; and inputting a second video signal to the liquid crystal display during a second period of time and controlling the light source by means of modulating the light control signal, wherein modulation modes of the light control signal are different during the first period of time and the second period of time.

### CROSS REFERENCE TO RELATED APPLICATION

This application claims the priority benefit of Taiwan Patent Application Serial Number 095128592, filed on Aug. 4, 2006, the full disclosure of which is incorporated herein by reference.

### BACKGROUND OF THE INVENTION

1. Field of the Invention

This invention generally relates to a displaying method for liquid crystal display, and more particularly, to a displaying method for reducing flickers of liquid crystal display.

2. Description of the Related Art

Conventional liquid crystal display (LCD) controls the rotation or twisting of liquid crystals by applying different potential differences between pixel electrodes and common electrodes so as to output different gray levels. However, the liquid crystals in LCD can not be kept in the same rotated or twisted state too long, e.g. when the frames form a steady picture, otherwise the characteristics of the liquid crystals may change and the liquid crystals may be unable to rotate or twist in accordance with different electric fields applied thereto to output desired different gray levels. In order to prevent the liquid crystals from deterioration due to an unchanged electric field, the voltage potential applied to the liquid crystals have to be alternated or returned to its original state within a specific time interval.

The polarities of the data voltages applied to a liquid crystal display are classified into positive polarity and negative polarity. The positive polarity denotes the voltages on pixel electrodes which are higher than that on common electrodes and the negative polarity denotes the voltages of pixel electrodes which are lower than that on common electrodes. As long as the absolute value of the applied voltage differences between the pixel electrodes and the common electrodes are identical, either the positive polarity or the negative polarity will produce the same gray levels while their rotating or twisting directions are opposite. The above features can prevent the liquid crystals from deterioration due to an unchanged electric field. In other words, when the frames displayed on the LCD screen form a steady picture, continuously alternating the polarities of the data voltages can still form the desired steady picture without deteriorating the liquid crystals. Generally, the polarities are alternated with the frame refresh.

However, if the frame refresh rate is too slow, the display screen may appear a flickering phenomenon. According to the regulation established by Video Electronics Standards Association (VESA), the definition of the flicker rate is represented as F%=(Iₚₚ/I_{AVE})×100%, referring to FIG. 1, where Iₚₚ indicates a peak-to-peak luminance value in any pixel on the screen and I_{AVE} indicates an average luminance value of the same pixel. Normally, the flicker rate is regulated to be lower than 5% in the central area of a screen and to be lower than 8% in the edges of the screen so as to conform to the specification of the liquid crystal display.

In a dot inversion system, each dot (or pixel) has opposite polarity with respect to the adjacent four dots and the polarity of each dot is inverted when the frame is refreshed, as shown in FIG. 2a. Since positive and negative polarities are appearing in the same frame, the flicker appearing on the screen could be compensated. But the transverse voltage differences between adjacent dots are larger, e.g. the transverse voltage difference is 10 volt as in FIG. 2a, and this will cause a larger transverse electric field thereby generating larger fringe effect in the dot inversion system.

In a frame inversion system, as shown in FIG. 2b, all dots (or pixels) in a frame have the same polarities; therefore, the transverse voltage differences are smaller, e.g. a transverse voltage difference is only 2 volt as in FIG. 2b, and hence the fringe effect can be reduced. The method to refresh frames in the frame inversion system is to divide a frame into an odd field and an even field. When a driving signal sequentially enables liquid crystals in accordance with the odd and even fields, the response waveforms (rotating or twisting waveforms) of liquid crystals of the odd fields may be asymmetric with those of the even fields due to the feedthrough effect of the transistors in the LCD, as shown in FIG. 3, wherein the waveforms with solid line indicate the driving voltage (data voltage) waveforms and the waveforms with dotted line indicate the response waveforms of liquid crystals. As shown, the flicker is more apparent in a frame inversion system due to the asymmetry of the waveforms between the odd and even fields. In additions, it should be understood that only 9 dots (pixels) of a frame are shown herein to simplify the illustration. In practical use, different pixel numbers may be utilized according to the actual size of the display panel.

Conventional methods increase the frame refresh rate to solve the flicker existing in a frame inversion system. For example, the refresh rate is increased from 60 hertz to 120 hertz, i.e. refreshing a frame in about 8.3 ms. However, in practical operation, a frame buffer has to be added into the display system by using this method to reduce flicker. The complexity, cost and size of the display system will be increased at the same time. In this manner, the method is not suitable to small size products, e.g. liquid crystal on silicon (LCOS) display.

Accordingly, it is necessary to improve the above mentioned displaying method for reducing flickers of liquid crystal display so as to reduce the complexity and manufacturing cost of a display system.

### SUMMARY OF THE INVENTION

It is an object of the present invention to provide a displaying method for liquid crystal display, which can compensate asymmetric response waveforms of the liquid crystals by modulating a light control signal of the liquid crystal display so as to reduce flickers existing thereof.

It is another object of the present invention to provide a displaying method for liquid crystal display, which can compensate asymmetric response waveforms of the liquid crystals by modulating a light control signal of the liquid crystal display so as to decrease the complexity of the display system.

It is a further object of the present invention to provide a displaying method for liquid crystal display, which can compensate asymmetric response waveforms of the liquid crystals by modulating a light control signal of the liquid crystal display so as to decrease the size of the display system.

In order to achieve the above objects, the present invention provides a displaying method for liquid crystal display having a light source integrated therein. The displaying method includes the steps of: inputting a first video signal to the liquid crystal display during a first period of time and controlling the light source by means of modulating a light control signal; and inputting a second video signal to the liquid crystal display during a second period of time and controlling the light source by means of modulating the light control signal, wherein modulation modes of the light control signal are different during the first period of time and the second period of time.

### BRIEF DESCRIPTION OF THE DRAWINGS

Other objects, advantages, and novel features of the present invention will become more apparent from the following detailed description when taken in conjunction with the accompanying drawings.

FIG. 1 shows a timing diagram of the luminance with respect to time in a conventional liquid crystal display.

FIG. 2a shows a schematic diagram of voltage polarities applied to liquid crystals in a dot inversion system.

FIG. 2b shows a schematic diagram of voltage polarities applied to liquid crystals in a frame inversion system.

FIG. 3 shows a timing diagram of the driving signal waveform and the transition waveform of liquid crystals.

FIG. 4 shows a flow chart of the displaying method for liquid crystal display according to one embodiment of the present invention.

FIG. 5 shows a schematic diagram of the modulation to the light source by the displaying method for liquid crystal display according to the embodiment of the present invention.

FIG. 6 shows another schematic diagram of the modulation to the light source by the displaying method for liquid crystal display according to the embodiment of the present invention.

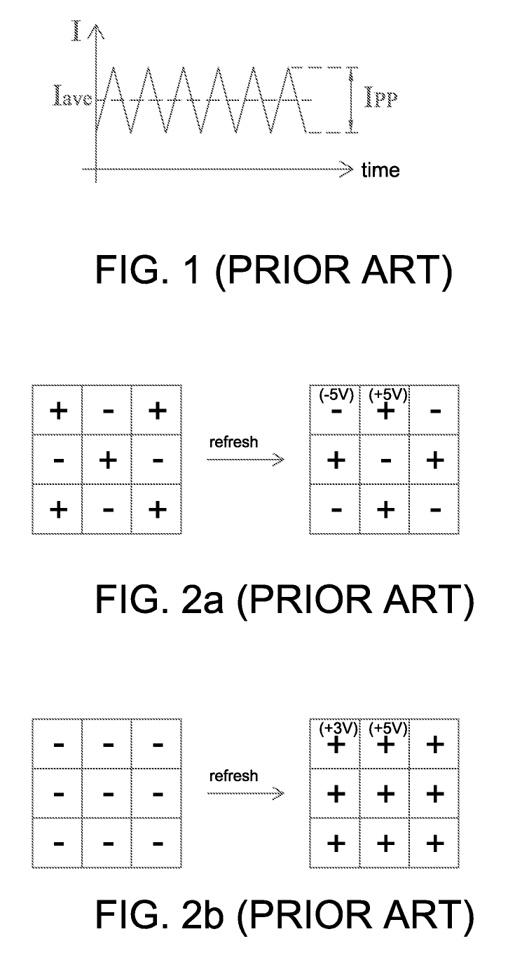

### DETAILED DESCRIPTION OF THE PREFERRED EMBODIMENT

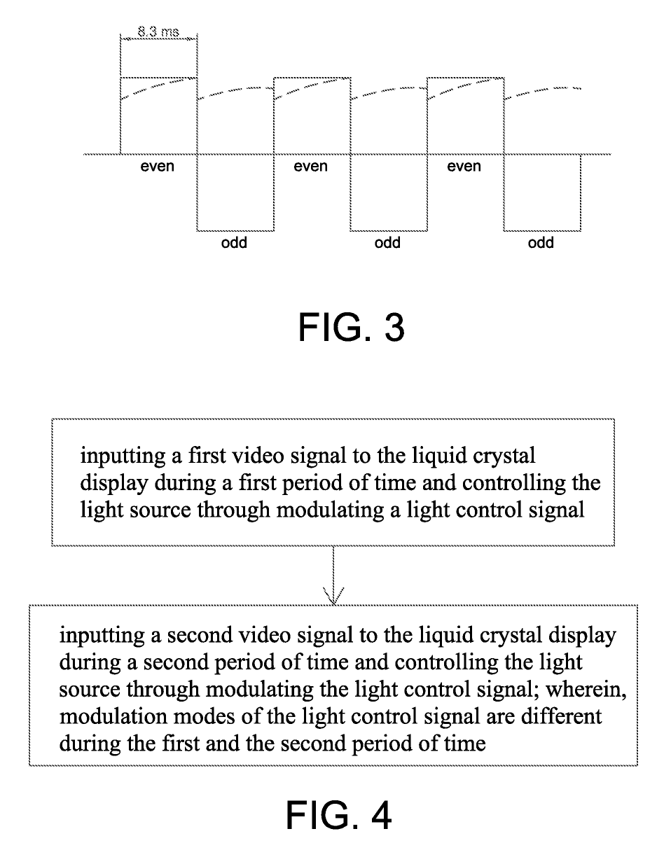

Referring to FIGS. 3 and 4, they illustrate the displaying method for liquid crystal display (LCD) according to one embodiment of the present invention. The method includes the steps of inputting a first video signal to the liquid crystal display during a first period of time and controlling a light source by means of modulating a light control signal; and inputting a second video signal to the liquid crystal display during a second period of time and controlling the light source by means of modulating the light control signal; wherein modulation modes of the light control signal are different during the first period of time and the second period of time. In this embodiment, the LCD utilizes a set of LEDs (light emitting diodes) as its light source and utilizes frame inversion to refresh the frames, wherein the refresh rate is identical to a local broadcasting frequency (for example 60 hertz in Taiwan, i.e. refreshing a frame per 16.6 ms and 50 hertz in England, i.e. refreshing a frame per 20 ms; that is the frame refresh rate is between 50 to 70 hertz). Since it is not necessary to double the frame refresh rate, the system complexity, manufacturing cost and size can be reduced so as to be adapted to a small size LCD system, e.g. liquid crystal on silicon (LCOS) display.

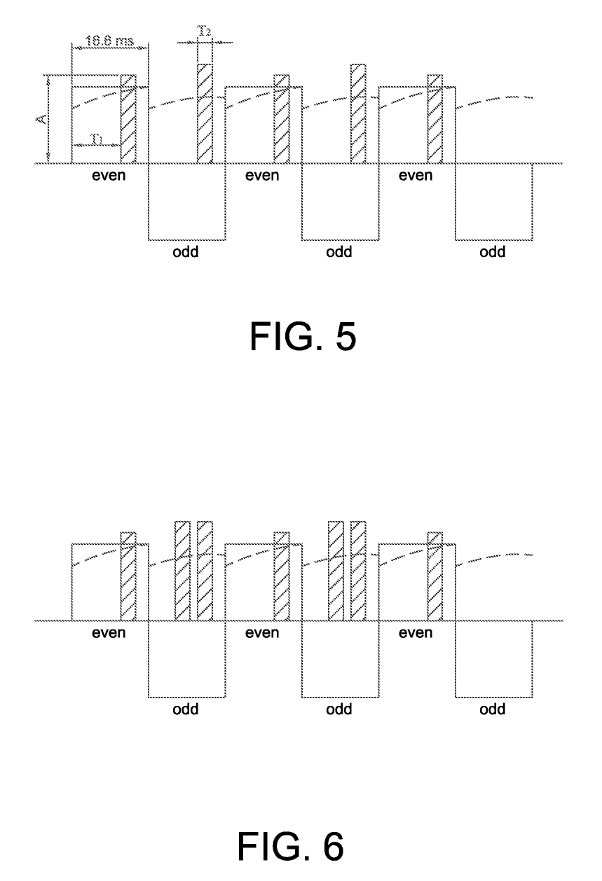

Referring to FIG. 5, it shows the way to implement the displaying method for liquid crystal display according to the embodiment of the present invention, wherein the waveforms with solid line indicate voltage waveforms of the video signals for driving the twisting or rotation of liquid crystals. The LCD in this embodiment utilizes frame inversion as a way to refresh frames and incorporates with even and odd fields of the frames such that the driving voltage waveforms of the video signals are alternatively varied between positive polarity and negative polarity. When the current field is an even field, the driving voltage waveform of the video signal is positive polarity; on the contrary, when the current field is an odd field, the driving voltage waveform of the video signal is negative polarity. However in practical, the polarities of driving voltage waveforms respectively with respect to odd and even fields may be exchanged. In this manner, liquid crystals will not be kept in the same states too long thereby preventing deterioration of characteristics of the liquid crystals in the LCD. The waveforms with dotted line indicate the response waveforms of the liquid crystals in accordance with the variation of the video signals, and the waveforms during odd fields (negative polarity in this embodiment) are not symmetric to the waveforms during even fields (positive polarity in this embodiment) due to the feedthrough effect of the transistors in the LCD. The areas filled with oblique lines as shown in the figure indicate enabling waveforms of the light source enabled by the light control signal. The time to enable the light source have to be a regular relationship with respect to the frame refresh time, e.g. enabling the light source while liquid crystals substantially accomplishing twisting or rotating, so as to display images correctly.

After the above step is finished, the LCD can display images correctly; however, due to the asymmetry of the waveforms between positive and negative polarities, the luminance of the images during odd fields is lower than that during even fields, and obvious flickers still exist during playing images. Before the light control signal is modulated, the LCD preferably displays images under a gray level which is sensitive to human eyes, e.g. between 1/10 and ⅕ of the largest gray level of the liquid crystal display such as 25 or 50 gray levels, so as to facilitate the process of flicker adjusting. In addition, this step can be performed or omitted during practical adjusting procedure.

Referring to FIGS. 5 and 6, they indicate the way to implement the control of the light source by means of modulating the light control signal according to the embodiment of the present invention. Due to the asymmetry of the response waveforms between positive and negative polarities, the modulation of the light control signal during the odd and even fields have to be different so as to lower the flicker rate of the LCD to be under a predetermined value, e.g. between 3% and 8%, wherein 5% will be taken as an example in the description hereinafter. The present invention modulates the light control signal to control the lighting mode of the light source so as to compensate the asymmetry of the response waveforms between positive and negative polarities, and the modulating method is to adjust at least one or a combination of the enable phase T1, pulse width T2 and amplitude of the light control signal and to control the light source to respectively generate at least one enable pulse to enable the light source during each odd and even field. FIG. 5 shows a schematic diagram of the enabling waveforms of the light source wherein one enable pulse is respectively generated during each odd and even field. It is assumed that the liquid crystals finish twisting or rotating at time T1 after being enabled; therefore, the enablement of the light source is started at the same time. In this embodiment, the flicker rate is reduced to be lower than 5% by adjusting the enable phase T1 so as to conform to the specification of the LCD. The pulse width T2 indicates the time interval that the light control signal enables the light source during each odd and even field, and the luminance of the light source is higher if the pulse width T2 is longer. In this embodiment, the flicker rate is reduced to be lower than 5% by adjusting the pulse width T2 so as to conform to the specification of the LCD. When the amplitude of the light control signal is larger, the luminance of the light source is higher, i.e. the amplitude “A” of the light control signal is larger as shown in FIG. 5. In this embodiment, the flicker rate is reduced to be lower than 5% by adjusting the amplitude “A” of the light control signal so as to conform to the specification of the LCD. In addition, in the present invention, at least one of the enable phase T1, pulse width T2 and amplitude “A”, or their combination may be adjusted to suppress the flicker rate to be lower than 5%. In some cases, it is unable to obtain apparent affect on reducing the flicker rate when adjusting only one of the enable phase T1, pulse width T2 and enable current. Accordingly, the second or the third of them may be adjusted simultaneously. For example, the enable phase Ti is first adjusted, but if continuously adjust the enable phase T1 no longer apparently reducing the flicker rate, then the pulse width T2 and/or the amplitude “A” may be adjusted till the flicker rate is lower than 5%.

In addition, during the processing of modulating the amplitude “A” of the light control signal, it is unable to increase the amplitude too large due to the rate limitation of the system, or the using life of the device may be decreased and device damage may be induced. In, this manner, by inputting only one enable pulse may not be able to reduce the flicker rate lower than the predetermined value, e.g. 5%. In an alternative embodiment, two enable pulses can be inputted to reduce the flicker rate to be lower than the predetermined value as shown in FIG. 6.

As mentioned above, conventional method reduces flickers of LCD by increasing the refresh rate, but it may have the problems of increasing the complexity and the manufacturing cost of the system. The displaying method for liquid crystal display of the present invention can compensate the asymmetry of the response waveforms of liquid crystals by means of modulating the light control signal to control the lighting mode of the light source in the LCD, as shown in FIG. 5 and FIG. 6, and the complexity and the cost of the display system are indeed decreased.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A displaying method for liquid crystal display, which comprises a light source integrated therein, comprising the steps of:
inputting a first video signal to the liquid crystal display during a first period of time and controlling the light source by means of modulating a light control signal; and
inputting a second video signal to the liquid crystal display during a second period of time and controlling the light source by means of modulating the light control signal;
wherein modulation modes of the light control signal are different during the first period of time and the second period of time.

2. The displaying method for liquid crystal display as claimed in claim 1, wherein the first and the second video signals have different polarities.

3. The displaying method for liquid crystal display as claimed in claim 1, wherein the modulation modes are enable phases of the light control signal.

4. The displaying method for liquid crystal display as claimed in claim 1, wherein the modulation modes are pulse widths of the light control signal.

5. The displaying method for liquid crystal display as claimed in claim 1, wherein the modulation modes are amplitudes of the light control signal.

6. The displaying method for liquid crystal display as claimed in claim 1, wherein the modulation modes are numbers of the enable pulses of the light control signal.

7. The displaying method for liquid crystal display as claimed in claim 1, wherein the modulation modes comprise at least two of the enable phases, the pulse widths, the amplitudes and numbers of the enable pulses of the light control signal.

8. A displaying method for liquid crystal display, comprising the steps of:
enabling a light source by means of a first lighting mode during a first frame period; and
enabling the light source by means of a second lighting mode during a second frame period.

9. The displaying method as claimed in claim 8, wherein the liquid crystal display is operated in frame inversion mode.

10. The displaying method as claimed in claim 8, wherein the first and the second lighting modes enable the light source with different enable phases.

11. The displaying method as claimed in claim 8, wherein the first and the second lighting modes enable the light source with different luminance.

12. The displaying method as claimed in claim 8, wherein the first and the second lighting modes enable the light source with different enable time.

13. The displaying method as claimed in claim 8, wherein the first and the second lighting modes enable the light source with different numbers of the enable pulses.
